(19) United States
(12) Patent Application Publication
(10) Pub. No.: US 2005/0273804 A1
(43) Pub. Date: Dec. 8, 2005

(54) Animated interactive polling system, method, and computer program product

(75) Inventor: David Preisman, New York, NY (US)

Correspondence Address: VENABLE LLP, P.O. BOX 34385, WASHINGTON, DC, 20045-9998, US

(73) Assignee: Showtime Networks Inc., New York, NY (US)

(21) Appl. No.: 10/843,456

(22) Filed: May 12, 2004

(51) Int. Cl. H04N 7/173; H04H 9/00; H04N 7/16

(52) U.S. Cl. 725/24; 725/135

(57) ABSTRACT

A method of performing a poll, including the steps of presenting the poll to a plurality of users, receiving a response from each of the plurality of users, compiling an aggregated polling result, and displaying an animated, continually-updated depiction of the aggregated polling result.

### BACKGROUND OF THE INVENTION

1. Field of the Invention

The present invention relates to polling. More particularly, the present invention relates to conducting interactive polls in an interactive television environment.

2. Related Art

Early, polls were compiled manually by such organizations as media groups and publishers. With the advent of widespread use of interactive television (ITV) and the Internet, polling of viewers or of a television audience can now be performed in an automated fashion along with programming content.

Polling can be used in combination with various conventional types of TV programming. For example, polls can be taken about events. More particularly, polls can also be taken about live events. One type of event about which a poll can be taken is a sporting event. Examples of other types of TV programming, about which one might want to take a poll include, e.g., news, sports, weather, politics, sitcoms, soap operas, elections, reality-based, game shows, movies, dramas, children's programming, and educational programming. There are various subcategories of programming as well. For example, sports programs may include, e.g., boxing, baseball, basketball, football, tennis, golf and the like.

Unlike conventional broadcast television, ITV provides a means for receiving user feedback over, e.g., a back channel, enabling interactivity. ITV clients can be used to distribute content to and to receive responses from viewers. Content can include, for example, television programming such as, e.g., a programming service. An example of a programming service is a subscription programming service, such as, e.g., SHOWTIME, available from SHOWTIME NETWORKS INC. of New York, N.Y., USA. A programming service can deliver via a content distributor various types of programming content for viewing by viewers. Content can also include ITV data. Exemplary ITV technology providers include, e.g., WINK and OPENTV available from Liberty Broadband Interactive Television of Tulsa, Okla. USA. Content providers can distribute content by uploading content to any of various content distributors who can deliver the content to viewers. Examples of content distributors include, e.g., COMCAST CORPORATION of Philadelphia, Pa., USA, DIRECTV of El Segundo, Calif. USA; and TIME WARNER CABLE of Stamford, Conn. USA. Conventionally, content is distributed over various network platform types including, e.g., voice, data, cable television (CATV), wireless communications networks, satellite TV, multichannel multipoint distribution service (MMDS) and wireless fidelity (WI-FI).

Conventional polls provide only a static representation of poll results. What is needed then is an improved technique of collecting polling results that overcomes shortcomings of conventional solutions.

### SUMMARY OF THE INVENTION

An exemplary embodiment of the present invention is directed to a system, method, and computer program product for animated interactive polling.

An exemplary embodiment of the invention is directed to a system for conducting a poll. The system may include a first network operations center (NOC) for providing content. The content includes television programming and/or data. The data may include the poll and/or a polling response. The system also may include a plurality of client devices. Each of the plurality of client devices may be for a respective one of a plurality of users. Each of the plurality of client devices may include a display, a receiver, and an interactive input device, such as a remote control, personal digital assistant, or other wireless device, and may be adapted to present the poll to the user, to receive the polling response from the user, to transmit the polling response from the user to the first NOC, to receive aggregated polling responses from the first NOC, to calculate a range of aggregated poll results, and to display in an animated, continually-updated fashion the range of aggregated poll results to the user. The system may also include distribution network facilities and the first NOC may be adapted to receive the polling responses from each of the client devices, to compile the aggregated polling responses, and to transmit the aggregated polling responses to the plurality of client devices.

In a further embodiment of the invention, a method for polling may be provided. The method may include the steps of presenting the poll to a plurality of users, receiving a response from each of the plurality of users, compiling an aggregated polling result, and displaying an animated, continually-updated depiction of the aggregated polling result.

In still a further embodiment of the invention, a further method for polling is provided. The method may include the steps of providing content to a plurality of users, the content including programming or data, wherein the data may include a poll, presenting the poll to each of the plurality of users, collecting votes for the poll, or providing an animated, continually-updated depiction of aggregated polling results to the plurality of users.

Further features and advantages of the invention, as well as the structure and operation of various embodiments of the invention, are described in detail below with reference to the accompanying drawings.

### BRIEF DESCRIPTION OF THE DRAWINGS

The foregoing and other features and advantages of the invention will be apparent from the following, more particular description of exemplary embodiments of the invention, as illustrated in the accompanying drawings. In the drawings, like reference numbers generally indicate identical, functionally similar, and/or structurally similar elements. The drawing in which an element first appears is indicated by the leftmost digits in the corresponding reference number. A preferred exemplary embodiment is discussed below in the detailed description of the following drawings:

FIG. 1 depicts an exemplary embodiment of an interactive television environment for polling;

FIG. 2 depicts an exemplary embodiment of a first interactive television client for polling;

FIG. 3 depicts an exemplary embodiment of a second interactive television client for polling;

FIG. 4A depicts an exemplary embodiment of a software architecture module for an exemplary content provider according to the present invention;

FIG. 4B depicts an exemplary embodiment of a software architecture module for an exemplary ITV client according to the present invention;

FIG. 5A depicts an exemplary embodiment of an interface for receiving latest round polling in an interactive television environment;

FIG. 5B depicts an exemplary embodiment of an interface for displaying aggregated polling results in a continuously animated manner in an interactive television environment;

FIG. 5C depicts an exemplary embodiment of an interface for displaying aggregated polling results in a minimized representation providing the results in a continuously animated manner in an interactive television environment according to the present invention; and

FIG. 6 depicts an exemplary embodiment of a computer and/or communications system as can be used for several components in an exemplary embodiment of the present invention.

### DETAILED DESCRIPTION OF AN EXEMPLARY EMBODIMENT OF THE PRESENT INVENTION

A preferred exemplary embodiment of the invention is discussed in detail below. While specific implementations are discussed, it should be understood that this is done for illustration purposes only. A person skilled in the relevant art can recognize that other components and configurations may be used without parting from the spirit and scope of the invention.

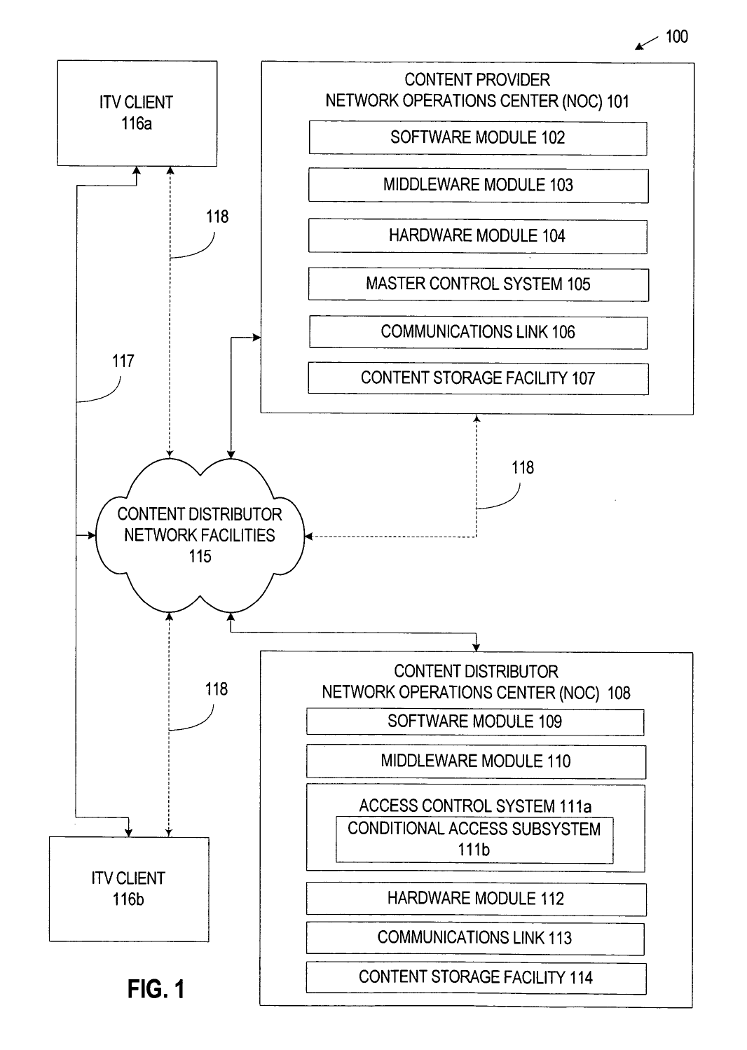

FIG. 1 depicts an exemplary embodiment of an interactive television (ITV) environment 100 that can be used to conduct a poll according to the present invention. Although the embodiment uses an ITV environment to illustrate the present invention, the present invention may also be used in other environments as will be apparent to those skilled in the art. The ITV environment 100, in an exemplary embodiment, can include a content provider network operation center (NOC) 101, a plurality of ITV clients 116a, 116b, and a content distributor NOC 108, coupled to one another by content distributor network facilities 115. The ITV environment 100 of FIG. 1 also illustrates, in an exemplary embodiment, a distribution channel 117 for broadcasting content to the ITV clients 116a, 116b from the content providers over the content distribution network 115, and a backchannel 118 for receiving interactive responses from the ITV clients 116a, 116b at the content provider. The exemplary environment is intended to be illustrative, but not limiting, or exhaustive.

Content provider NOC 101 can include, e.g., a software module 102 and a middleware module 103 running on top of a hardware module 104. The content provider NOC 101 can also include a master control system 105 for assembling programming service content stored in a content storage facility 107 for distribution. The content provider NOC 101 can also include a communications link 106, which may be a distribution uplink, that can be used to upload content to the content distributor for distribution to ITV clients 116a, 116b.

Content distributor NOC 108 can include a software module 109, a middleware module 110, and an access control system 111a including, e.g., a conditional access subsystem 111b, running on a hardware module 112. A communications link 113, which may be a distribution downlink, can be used, in an exemplary embodiment, to download content from the content providers to the content distributor NOC 108, for temporary storage in content storage facility 114, prior to distribution via the content distributor network 115 to ITV clients 116a, 116b for viewing by viewers.

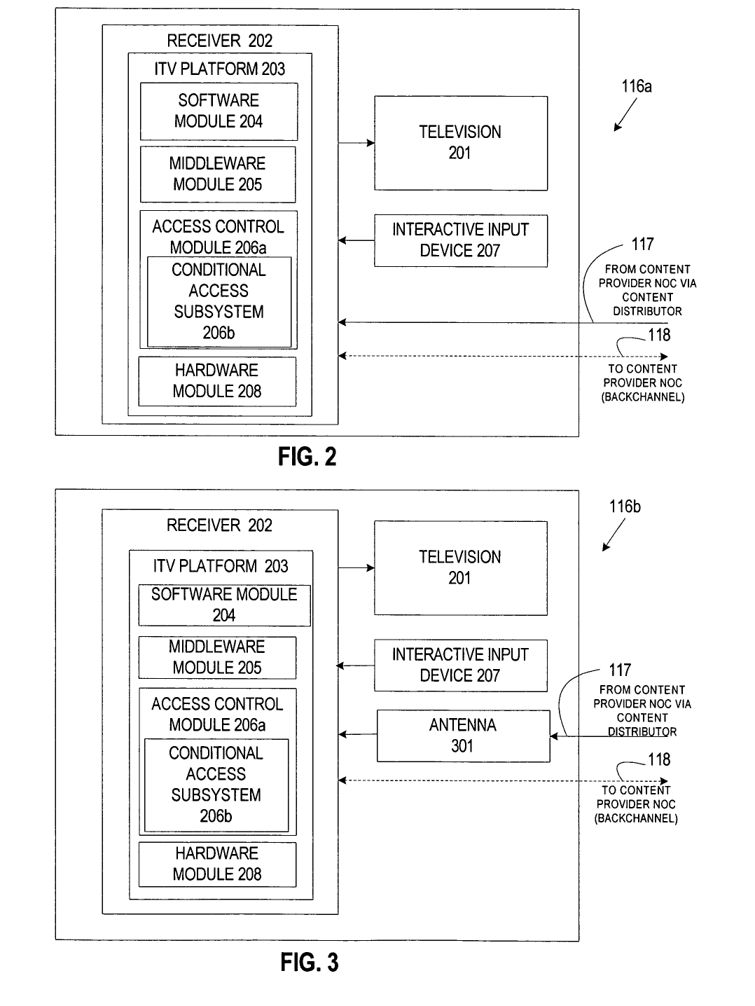

As shown in FIG. 2, an exemplary ITV client 116a can include, in an exemplary embodiment, a television 201, a receiver 202, and an interactive input device 207, which may be a remote control. Receiver 202 can include, in an exemplary embodiment, ITV platform 203 that can include, e.g., a software module 204, a middleware module 205, an access control module 206a, which may include, e.g., a conditional access subsystem 206b (such as, e.g., a smart card), and hardware module 208. As shown in FIGS. 1 and 2, receiver 202 can also be configured to receive content from content provider NOC 101 via a communications link 117 of a content distributor network 115 and content distributor NOC 108 directly via interface equipment, for example. The exemplary ITV platform 203 of FIG. 2 can be thought of as an example environment that could be used for a content distributor that uses a cable television (CATV) network. Content can be distributed to ITVs 116a, 116b from the content provider over content distributor network facilities 115 as shown in line 117. Dotted line 118 represents an exemplary back channel 118 for sending interactive information to the content provider. In one exemplary embodiment, content and interactive information can be transmitted to and from ITV clients 116a, 116b directly from and to content provider NOC 101. In another exemplary embodiment, as illustrated, interactive information can be sent to content provider NOC 101 via the content distributor network 115 and/or back channel 118. Although referred to as a back channel 118, as will be apparent to those skilled in the relevant art, the back channel 118 can include, e.g., bi-directional or unidirectional communication links as well as, e.g., in band, or out of band communications channels. For example, communication can occur over, e.g., and Internet protocol such as, e.g., a simple mail telecommunications protocol (SMTP), or a hypertext transfer protocol (HTTP).

Alternatively, as is shown in FIG. 3, receiver 202 can be configured to receive content from content provider NOC 101 via content distributor network 115 and content distributor NOC 108 an via an antenna 301, such as, e.g., a satellite dish or the like. Similarly, communication can be direct between ITV clients 116a, 116b and the content provider, or via a content distributor.

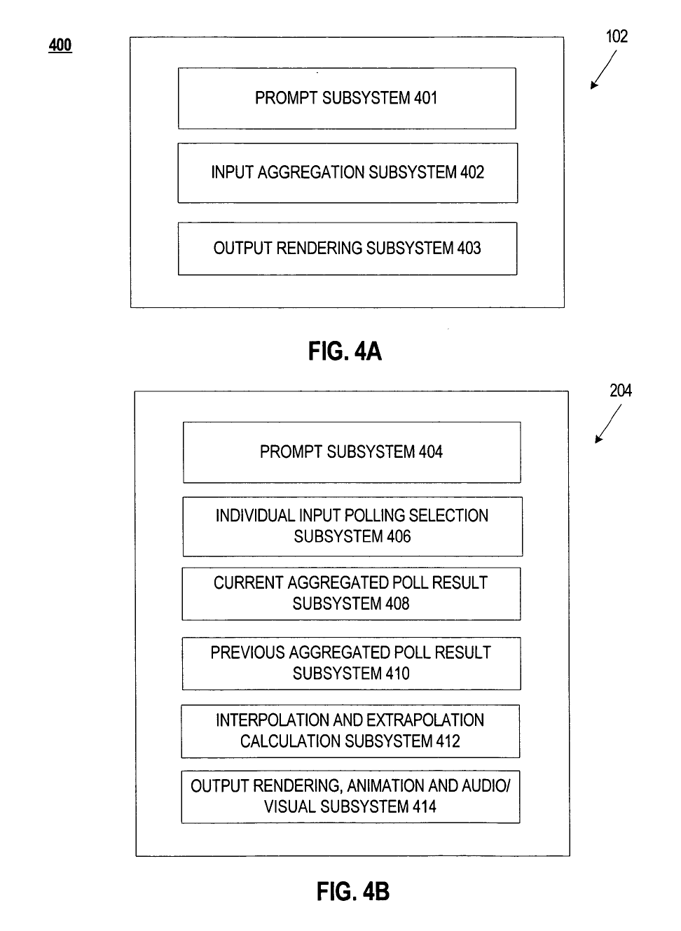

FIG. 4A depicts an exemplary polling server software architecture diagram 400 illustrating an exemplary software module 102 of the content provider NOC 101 which can run on hardware module 104. In an exemplary embodiment, polling software architecture diagram 400 can include an application suite including software modules including, e.g., a prompt subsystem 401, an input aggregation subsystem 402, and an output rendering subsystem 403.

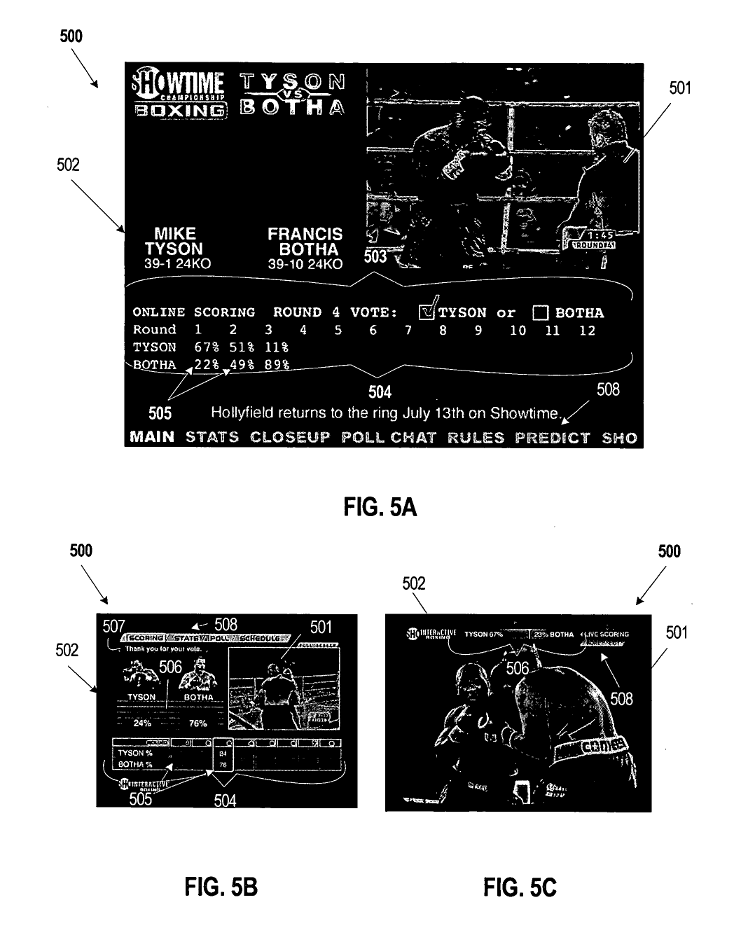

The prompt subsystem 401 can work in coordination with software modules 204 on ITV clients 116a, 116b, to prompt viewers of televisions 201 or other client devices such as, e.g., a display, to provide input in response to a poll question. In an exemplary embodiment of FIGS. 5A-5C, a sports poll is illustrated. Although a boxing sporting event is illustrated, other polls, or interactive questionnaires, or the like may also use the present invention.

The input aggregation subsystem 402, in an exemplary embodiment, can aggregate input collected, compiled and analyzed from multiple viewers using, e.g., interactive input device 207 and ITV clients 116a, 116b, from multiple content distributors similar to the exemplary content distributor described. Advantageously, according to an exemplary embodiment of the present invention, results can be aggregated from various content distributors and can be analyzed at the content provider. Exemplary analysis can include, e.g., creating graphical charts, visualizations, statistical analyses, and/or graphical renderings for later distribution.

The output rendering subsystem 403, in an exemplary embodiment, can take aggregated polling results from various viewers, on various content distributor networks, and can in coordination with ITV clients 116a, 116b, generate graphical visualization renderings for display on televisions 201, which may be in realtime, of the results of the interactive poll. These graphical visualization renderings, can be animated, continually-updated depictions of the polling result. For example, in an exemplary embodiment of the invention, the graphical visualization rendering can be a continually-updating bar graph, pie chart, line graph, sliding indicator, or the like. In one exemplary embodiment of the invention, output rendering subsystem 403 can be located on ITV client 116a, 116b (collectively 116). In another exemplary embodiment, the output rendering subsytem may include a component executing at the content provider and another component executing on the client 116.

FIG. 4B depicts an exemplary ITV client polling client software architecture diagram illustrating an exemplary software module 204 of the ITV client 116 which can run on hardware module 208. In an exemplary embodiment, the ITV client polling software architecture diagram can include an application suite including software modules including, e.g., a prompt subsystem 404, an individual input polling selection subsystem 406, current aggregated poll result subsystem 408, previous aggregated poll result subsystem 410, interpolation and extrapolation calculation subsystem 412 (for calculating one, or a range of values between the current and previous poll results), and output rendering, animation, and audio/visual subsystem 403. Another exemplary embodiment may include, e.g., a pre-event data collection, wagering, points tracking, and/or award module (not shown). In such an exemplary embodiment, the pre-event data collection, wagering, points tracking, and/or award module may prior to an event, such as, e.g., a boxing match, poll users and may calculate odds based on polling responses. The users can then wager points based on the expected fight results. In an exemplary embodiment, once the event is completed, award points, or other awards, may be distributed to winning users.

In one exemplary embodiment, if a user does not have a receiver capable of providing return feedback to the content provider NOC 101, the client software 204 can take aggregated results from the content provider NOC 101 and may add the user's individual vote into the results and may display the final aggregated results on the user's ITV client 116.

In an exemplary embodiment of the present invention, ITV clients 116a, 116b can receive content from content provider NOC 101. Content can include, for example, television programming such as, e.g., a programming service. An example of a programming service is a subscription programming service, such as, e.g., SHOWTIME, available from SHOWTIME NETWORKS INC. of New York, N.Y., USA. A programming service can deliver via a content distributor various types of programming content for viewing by viewers. Examples of programming included in a programming service may include movies and television programs. Examples of television programs can include, but are not limited to: sports programs, news broadcasts, reality television shows, a concert, a live event, a series episode, movies, game shows, or the like. Sports programs can include, e.g., boxing, baseball, basketball, football, tennis, golf and the like. Content may include, e.g., questions and responses. Content can also include ITV data, such as, e.g., an ITV application to conduct a poll. Exemplary ITV technology providers include, e.g., WINK and OPENTV available from Liberty Broadband Interactive Television of Tulsa, Okla. USA.

As will be understood by a person having ordinary skill in the art, content provider NOC 101 can distribute content via a communications link 106, e.g., such as a distribution, uplink to content distributor NOC 108. Content distributor NOC 108 can receive the content from content provider NOC 101 via a communications link 113 such as, e.g., a distribution downlink. Content distributor NOC 108 can then distribute content to ITV clients 116a, 116b through content distributor network facilities 115. In another exemplary embodiment, the content provider can directly transmit content and information to and receive content and information from ITV clients 116a, 116b. Examples of content distributors include, e.g., COMCAST CORPORATION of Philadelphia, Pa., USA, DIRECTV of El Segundo, Calif. USA; and TIME WARNER CABLE of Stamford, Conn. USA. Conventionally, content is distributed over various network platform types including, e.g., voice, data, cable television (CATV), wireless communications networks, satellite TV, multichannel multipoint distribution service (MMDS) and wireless fidelity (WI-FI). The content can then be distributed directly, or via, e.g., content distributor network facilities 115 and/or content distributor NOC 108 to ITV clients 116a, 116b.

To conduct an exemplary ITV poll according to an exemplary embodiment of the present invention, a user can be polled, e.g., before, during, or after viewing a television program or event, such as, e.g., a sporting event, news broadcast, reality television show, a concert, a live event, a series episode, movie, game show, or the like and may simultaneously interact with the television using interactive input device 207. Events can also include, for example, a debate, an election, a current event, a newsworthy event, or the like. Polls may be taken in relation to an event, however, polls according to an exemplary embodiment of the present invention need not be tied to an event and may instead be a prediction, opinion poll, quiz, and/or questionnaire seeking one or more responses that may be later tabulated into aggregated results for presentation in a manner according to the present invention. Interactive input device 207 can be, for example, a conventional remote control, a remote keyboard, a mouse, a personal digital assistant (PDA), or other wireless or wired device, and the like. Events may include any type of conventional programming event, including, e.g., live TV programming events. In the case of a sporting event, the sporting event can be any sporting event, such as, e.g., a boxing match, a horse race, an OLYMPIC games event, a basketball game, or any other similar sporting event.

During, before, or after a broadcast, a user can be prompted to participate in an interactive poll. An interactive poll can include, e.g., any question that may elicit a response from a viewer. For example, an interactive poll can be an opinion poll, a viewer's prediction, a “quiz”, and/or questionnaire where the viewer is asked to test his or her knowledge in a multiple choice question, for example. In an exemplary embodiment of the invention, the interactive poll can occur before, during, or after the event, and can be related to the broadcast, or some other event, such as, e.g., a debate, an election, or some other current event. Further, in an exemplary embodiment of the present invention, an exemplary interactive poll can include, e.g., providing continually-updated results, which may be in realtime, or near realtime, along with a program. In the exemplary embodiment, polling results may be obtained from viewers in response to the questions posed via ITV clients 116a, 116b and may be collected, temporarily stored, forwarded to the content provider, aggregated by the content provider, and/or aggregated results may be transmitted, and/or displayed for viewing by the viewers in enhanced content that may be delivered via facilities 115 of the content distributors. A boxing example is used for illustrative purposes in this application, but it will be apparent to those skilled in the relevant art that the boxing illustration is provided as an example only and is equally applicable to any other sports programming event, other television programming event, or other event, topic, or issue. The exemplary boxing example of the exemplary embodiment of the present invention is described below with reference to FIGS. 5A-5C.

FIG. 5A depicts an exemplary embodiment of an ITV environment 500 for conducting an ITV poll. ITV environment 500 can include, in an exemplary embodiment, broadcast 501, interactive portion 502, voting prompt 503, results display 504, aggregated poll results 505, and navigation bar 508. ITV environment 500 can create a so-called picture-in-picture (PIP) environment (as shown in FIG. 5A), for example, or an overlay environment (as shown in FIG. 5C), or a fullscreen environment (not shown). As shown in FIG. 5A, a user can be presented with an opportunity to vote using voting prompt 503. The user can use the interactive input device 207 to navigate between choices and may select an option of the poll. As indicated in FIG. 5A, the user may have voted for fighter Tyson in voting prompt 503. Once the user submits a vote, in an exemplary embodiment of the invention, ITV client 116a, 116b can submit the vote to content provider NOC 101 via content distributor network facilities 115. Content provider NOC 101 can aggregate the votes received from some or all of the ITV clients 116a, 116b and then may submit an aggregated poll result back to the ITV clients 116a, 116b. In an exemplary embodiment of the invention, the aggregated poll result can be provided to the user or displayed in ITV environment 500 using results display 504. In an exemplary embodiment, the content provider NOC 101 can send aggregated results values to client 116 for all voting choices, and then software 204 on ITV client 116 can further analyze the results. As shown in FIG. 5A, results display 504 can display the aggregated poll results 505, e.g., in numerical and graphically animated fashion.

FIG. 5B also depicts an exemplary embodiment of an ITV environment 500 for conducting an ITV poll. ITV environment 500 can include, in an exemplary embodiment, broadcast 501, interactive portion 502, results display 504, aggregated poll results 505, results depiction 506, message bar 507, and navigation bar 508. In ITV environment 500 of FIG. 5B, a poll can be conducted as described above. Once the results are aggregated, aggregated poll results 505 can be displayed using results display 504 and results depiction 506. Results depiction 506 can be, e.g., a continually-updating bar graph, pie chart, line graph, sliding indicator, or the like. In an exemplary embodiment of the invention, results depiction 506 can be continually updated. In another exemplary embodiment of the invention, result depiction 506 can be continually updated using interpolation techniques to provide smooth animation between a pair of data points, as would be understood by a person having ordinary skill in the art. In another embodiment of the invention, result depiction 506 can be continually updated using extrapolation techniques to provide extrapolated values of a series of data points to provide smooth animation of results as would be understood by a person having ordinary skill in the art.

To display an animated, continually-updated results depiction 506, ITV client 116a, 116b can receive instances of aggregated poll results 505, can continually recalculate a range of updated intermediate results, using, for example, interpolation and/or extrapolation, and may create an animated transition from the currently displayed result to a new result or over a range of results. Using animation techniques, the ITV client 116 can continually display an animation of the transition from one data point to the next. To the extent that extrapolation of trend information is used, upon receipt of a next instance of aggregated results, a transition to the new value can be created, in an exemplary embodiment. In an exemplary embodiment, two values may initially be provided. Using the two initial values, a transition may be shown.

FIG. 5C also depicts an exemplary embodiment of an ITV environment 500 for conducting an ITV poll. As shown in FIG. 5C, interactive portion 502 can overlay broadcast 501 In such an exemplary embodiment of the invention, ITV environment 500 can include results depiction 506 and navigation bar 508. Navigation bar 508 can be used to navigate a user through ITV environment 500, for example, or to switch between picture-in-picture mode (see FIGS. 5A and 5B) and overlay mode, as is shown in FIG. 5C. Results depiction 506 can be a sliding indicator that may be continually-updated using methods described above. In a further exemplary embodiment of the invention, in the event that an ITV client 116a, 116b cannot transmit a vote to content provider NOC 101 (i.e., where a system 100 or client 116 does not include an operating backchannel 118), aggregated poll result 505 can be transmitted to an ITV client 116a, 116b and ITV client 116a, 116b can factor in a corresponding user's vote and then may display the updated results using methods described above.

In yet a further exemplary embodiment of the invention, instead of polling users during a broadcast, users can be polled prior to, or after a broadcast. In such an exemplary embodiment, each users' vote can be stored by content provider NOC 101 or by an ITV client application (not shown) or on ITV client 116a, 116b until the end of the broadcast or until when needed. In the example given, users may be polled prior to the event. Based on the accumulated polling results, odds may be determined. In addition to casting a vote, a user can also, for example, wager “points” with his or her vote based on those odds. For example, using the boxing example described above, a group of users can be polled prior to a fight to determine who the users believe will win the fight. Each user can then wager points on the fight and can cast their vote before the fight begins. During, at the end, or after the fight, results can be displayed on television 201. During or after a fight, or series of fights, for example, results can be tallied and may be superimposed in a broadcast using an ITV environment as described above, for example. When results are superimposed in the broadcast, the results can be superimposed using, e.g., a traditional video feed (i.e., on-air graphics), for example, or alternatively, using an enhanced ITV experience.

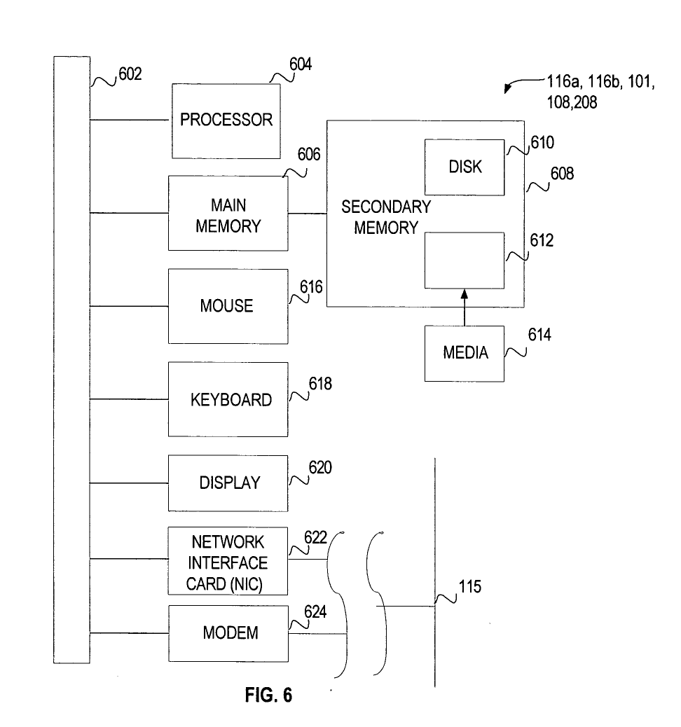

FIG. 6 depicts an exemplary computer system as can be used in a client device, an exemplary ITV client 116a, 116b, content provider NOC 101, content distributor NOC 108, or hardware module 208.

FIG. 6 depicts an exemplary embodiment of a computer and/or communications system as can be used for several components of the polling system in an exemplary embodiment of the present invention. FIG. 6 depicts an exemplary embodiment of a computer that may be used in ITV client 116a, 116b, hardware modules 104, 112, and 208 as can be used for several computing devices in the present invention. FIG. 6 is a block diagram of a computer workstation system that can be used for retrieving information using browsers such as, e.g., a web browser to interact with the interactive polling system of the present invention. The computer may be part of or can include, e.g., any computer device, or communications device including, e.g., a personal computer (PC), a workstation, a mobile device, a phone, a handheld PC, a personal digital assistant (PDA), a thin client, a fat client, an network appliance, an Internet browser, a paging, or alert device, a television, an interactive television, a receiver, a digital video recorder (DVR), a tuner, a high definition (HD) television, an HD receiver, a video on demand (VOD) system, a subscription VOD (SVOD) system, a server, or other device. The system can initiate and activate access to distributed content by interacting with application systems including, e.g., billing systems distribution facilities and other equipment, and can interact with and/or store data that can be stored on a database that can be accessible via a web server and/or an application server. The computer system is now described in the context of a workstation retrieving information from a database on an application server. The computer, in an exemplary embodiment, can comprise a central processing unit (CPU) or processor 604 coupled to a bus 602. Processor 604 can, e.g., access main memory 606 via bus 602. The computer can be coupled to an Input/Output (I/O) subsystem such as, e.g., a network interface card (NIC) 622, or a modem 624 for access to network 108. The computer can also be coupled to a secondary memory 608 directly via bus 602, or via main memory 606. Secondary memory 608 can include, e.g., a disk storage unit 610 or other storage medium. Exemplary disk storage units 610 can include, e.g., a magnetic storage device such as, e.g., a hard disk, an optical storage device such as, e.g., a write once read many (WORM) drive, or a compact disc (CD), or a magneto optical device. Another type of secondary memory 608 can include a removable disk storage device 612, which can be used in conjunction with a removable storage media 614, such as, e.g. a CD-ROM, or a floppy diskette. In general, the disk storage unit 610 can store an application program for operating the computer system referred to commonly as an operating system, such as, e.g., Windows 98/2000/XP® available from Microsoft Corporation of Redmond, Wash., USA, LINUX or other variations of UNIX such as, e.g., AIX from IBM Corporation of Armonk, N.Y., USA, or Solaris ® available from Sun ® Microsystems of San Francisco, Calif., USA. The disk storage unit 610 can also store documents of a database 112. The computer can interact with the I/O subsystems and disk storage unit 610 via bus 602. The bus 602 can also be coupled to a display 620 or print (not shown) for output, and input devices such as, e.g., a keyboard 618 and a mouse or other pointing/selection device 616 that can be used to a activate mouse pointer cursor.

The computer can, in an exemplary embodiment, execute a browser application program that can be used to enter responses to poll prompts, as well as to display information such as polling results for later output using information from databases. Databases can include any of various databases. The data can be retrieved from disk storage units 610 on the computer, or on another computer system such as, e.g., an application server, a provisioning server, a billing system, an access control system, a content streaming server, a data server, a video server, or other computer or server. In an exemplary embodiment, the search results can be displayed using a television, a display, a monitor, or a graphical user interface, or using an application program such as, e.g., one written in, e.g., a combination of Flash and Java programming language and can be implemented as a web browser enabled application or applet. The application program can include, e.g., a series of instructions that can cause the computer via, e.g., a browser, to retrieve documents, or parts thereof, which can be stored in one or more databases coupled to a server computer system such as, e.g., an application server. The GUI can advantageously display the polling results on display 620 for manipulation of the results by using, e.g., mouse 616. The GUI can be manipulated via other common devices such as, e.g., or an interactive remote device 207, or a keyboard 618, such as, e.g., the cursor arrow keys on the keyboard. Although the invention is described in reference to an ITV client 116, computer, or a computer workstation, another computing or communication device is equally suitable to using the present invention, such as, e.g., a wireless device, a communications device, a television and/or receiver, a personal digital assistant (PDA), an ITV client, a digital video recorder (DVR), a thin client, fat client, x-station, browser, or other network appliance.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents. While this invention has been particularly described and illustrated with reference to a preferred embodiment, it will be understood to those having ordinary skill in the art that changes in the above description or illustrations may be made with respect to formal detail without departing from the spirit and scope of the invention.

1. An system for conducting a poll, comprising:
a first network operations center (NOC) for providing content, said content including at least one of television programming or data, wherein said data includes at least one of the poll or a polling response;
a plurality of client devices, each of said plurality of client devices for a respective one of a plurality of users, each of said plurality of client devices having a display, a receiver, and an interactive input device, wherein each of said client devices is adapted to present the poll to the user, to receive the polling response from the user, to transmit the polling response from the user to said first NOC, to receive aggregated polling responses from said first NOC, to calculate an intermediate or a range of aggregated poll results, and to display in an animated, continually-updated fashion said intermediate or range of aggregated poll results to the user; and
a distribution network,
wherein said first NOC is adapted to receive said polling responses from each of said client devices, to compile said aggregated polling responses, and to transmit said aggregated polling responses to said plurality of client devices.

2. The system of claim 1 further comprising:
a second NOC adapted to receive said content from said first NOC and to transmit said content to said plurality of client devices via said distribution network.

3. The system of claim 2, wherein said first (NOC) further comprises:
a communications link adapted to distribute said content to said second NOC.

4. The system of claim 2, wherein said second (NOC) further comprises:
a communications link adapted to receive said content from said first NOC.

5. The system of claim 2, wherein said distribution network is adapted to receive said content from said second NOC and to distribute said content to said plurality of client devices.

6. The system of claim 2, wherein said distribution network facilities are further adapted to transmit the polling responses from said plurality of client devices to said first NOC.

7. The system of claim 1, further comprising:
a channel adapted to transmit the polling response from each of said plurality of client devices to said first NOC.

8. The system of claim 1, wherein each of said plurality of client devices is adapted to:
receive first and second instances of the aggregated polling responses, wherein the first instance represents the aggregated polling response at a first point in time and the second instance represents the aggregated polling response at a second point in time;
interpolate a transition from the first instance to the second instance; and
display an animation of the transition.

9. The system of claim 1, wherein each of said plurality of client devices is adapted to:
receive first and second instances of the aggregated polling responses, wherein the first instance represents the aggregated polling response at a first point in time and the second instance represents the aggregated polling response at a second point in time;
extrapolate from the first and second instances to determine a transition from the first and second instances to a third instance; and
display an animation of the transition.

10. The system of claim 1, wherein the poll is associated with an event.

11. The system of claim 10, wherein said event comprises at least one of television programming; a debate; a current event; an election; or a newsworthy event.

12. The system of claim 10, wherein said event comprises at least one of a sporting event; a reality television show; a concert; a live event; a news broadcast; a series episode; a movie; or a game show.

13. The system of claim 1, wherein the poll comprises at least one of:
a prediction, an opinion poll, a quiz, or a questionnaire.

14. The system of claim 1, wherein each of said plurality of client devices is an interactive television (ITV) device.

15. The system of claim 1, wherein one of said plurality of client devices is an interactive television (ITV) device and another of said plurality of client devices is an Internet device.

16. The system of claim 1, further comprising:
a unidirectional client device that is incapable of transmitting the polling response back to said first NOC, said unidirectional client having a display, a receiver, and an interactive input device and being adapted to present the poll to a unidirectional user, to receive a polling response from the unidirectional user, to receive the aggregated polling responses from said first NOC, to modify the aggregated polling responses based on the polling response from the unidirectional user, to calculate a modified range of modified aggregated poll results, and to display in an animated, continually-updated fashion said modified range of the modified aggregated poll results to the unidirectional user.

17. A method of performing a poll, comprising:
presenting the poll to a plurality of users;
receiving a response from each of the plurality of users;
compiling an aggregated polling result; and
displaying an animated, continually-updated depiction of the aggregated polling result.

18. The method according to claim 17, wherein said displaying comprises:
receiving first and second instances of the aggregated polling result, wherein the first instance represents the aggregated polling result at a first point in time and the second instance represents the aggregated polling result at a second point in time;
interpolating a transition from the first instance to the second instance; and
displaying an animation of the transition.

19. The method according to claim 17, wherein said displaying comprises:
receiving first and second instances of the aggregated polling result, wherein the first instance represents the aggregated polling result at a first point in time and the second instance represents the aggregated polling result at a second point in time;
extrapolating the first and second instances to determine a transition from the first and second instances to a third instance; and
displaying an animation of the transition.

20. The method according to claim 18, wherein said interpolating occurs at an interactive television (ITV) client of each of the plurality of users.

21. The method according to claim 19, wherein said extrapolating occurs at an interactive television (ITV) client of each of the plurality of users.

22. The method according to claim 18, wherein the animation comprises a continually-updated graphical display.

23. The method according to claim 19, wherein the animation comprises a continually-updated graphical display.

24. The method according to claim 22, wherein the animation comprises at least one of a sliding indicator, a bar graph, a pie chart, or a line graph.

25. The method according to claim 23, wherein the animation comprises at least one of a sliding indicator, a bar graph, a pie chart, or a line graph.

26. The method according to claim 17, wherein the poll relates to an event, the event comprising at least one of television programming; a debate; a current event; an election; or a news worthy event.

27. The method according to claim 26, wherein the television programming comprises at least one of: a sporting event, a reality television show, a concert, a live event, a news broadcast, a series episode, a movie, or a game show.

28. The method according to claim 27, wherein said sporting event comprises at least one of: a boxing match; a horse race; a baseball game; a football game; a basketball game; a soccer match; or a tennis match.

29. The method according to claim 7, wherein the poll comprises at least one of: a prediction, an opinion poll, a quiz, or a questionnaire.

30. The method according to claim 17, wherein said event comprises a boxing match and wherein said aggregated polling result comprises a round-by-round scoring between two boxers.

31. The method according to claim 30, wherein said round-by-round scoring comprises a graphical indication of which boxer is believed by the plurality of users to be winning the match according to the aggregated polling result.

32. The method according to claim 31, wherein said graphical indication comprises at least one of: a sliding indicator; a line graph; a bar chart; or a pie chart.

33. The method according to claim 17, wherein said receiving step comprises receiving said responses from each of the plurality of users from an interactive television (ITV) client.

34. The method according to claim 17, wherein the response from each of the plurality of users is received directly by a content provider.

35. The method according to claim 17, further comprising:
presenting the poll to a unidirectional user who is incapable of transmitting the response via a back channel;
receiving input from the unidirectional user;
transmitting the aggregated polling result to the user;
calculating a modified polling result based on the input and the aggregated polling result; and
displaying an animated, continually-updated depiction of the modified polling result.

36. A method for polling, comprising:
providing content to a plurality of users, the content including at least one of programming or data, wherein the data includes a poll;
presenting the poll to each of the plurality of users;
collecting votes for the poll; and
providing an animated, continually-updated depiction of aggregated polling results to the plurality of users.

37. The method according to claim 36, wherein the collecting step includes each user using an interactive input device to transmit a vote to a receiver and receiving each vote from said receiver.

38. The method according to claim 36, wherein the collecting step further includes:
aggregating the votes into the aggregated polling result.

39. The method according to claim 36, wherein the providing content step includes:
transmitting the content from a content provider; and
distributing the content to a client device associated with each of the plurality of users via a distribution network.

40. The method according to claim 36, wherein said providing comprises:
receiving first and second instances of the aggregated polling result, wherein the first instance represents the aggregated polling result at a first point in time and the second instance represents the aggregated polling result at a second point in time;
interpolating a transition from the first instance to the second instance; and
displaying an animation of the transition.

41. The method according to claim 36, wherein said providing comprises:
receiving first and second instances of the aggregated polling result, wherein the first instance represents the aggregated polling result at a first point in time and the second instance represents the aggregated polling result at a second point in time;
extrapolating the first and second instances to determine a transition from the first and second instances to a third instance; and
displaying an animation of the transition.

42. The method according to claim 37, wherein said receiver is an interactive television (ITV) receiver.

43. The method according to claim 36, further comprising:
presenting the poll to a unidirectional user who is incapable of transmitting a vote via a back channel;
receiving input from the unidirectional user;
transmitting the aggregated polling result to the user;
calculating a modified polling result based on the input and the aggregated polling result; and
displaying an animated, continually-updated depiction of the modified polling result.
